(19) United States
(12) Patent Application Publication
(10) Pub. No.: US 2013/0220536 A1
(43) Pub. Date: Aug. 29, 2013

(54) METHOD OF APPLYING LIQUID ADHESIVE TO A SURFACE OF A METALLIC FAN BLADE

(71) Applicants: Michael Parkin, South Glastonbury, CT (US); Christopher J. Hertel, Wethersfield, CT (US)

(72) Inventors: Michael Parkin, South Glastonbury, CT (US); Christopher J. Hertel, Wethersfield, CT (US)

(21) Appl. No.: 13/408,158

(22) Filed: Feb. 29, 2012

(51) Int. Cl. B32B 37/12

(52) U.S. Cl. 156/285; 156/291

(57) ABSTRACT

A method of forming a fan blade includes the steps of applying an adhesive to an inner surface of a cover and moving a toothed instrument along the inner surface of the cover to spread the adhesive over the inner surface of the cover to form a plurality of rows of adhesive on the inner surface of the cover. The method further includes the steps of applying the inner surface of the cover to a fan blade body and curing the adhesive to secure the cover to the fan blade body.

### BACKGROUND OF THE INVENTION

A gas turbine engine includes a fan section that drives air along a bypass flowpath while a compressor section drives air along a core flowpath for compression and communication into a combustor section then expansion through a turbine section.

Fan blades are commonly made of titanium or carbon fiber. Sheet adhesive films, for example epoxy films, can be used to secure parts of the fan blade together as they are strong, durable, easy to apply, and have a consistent weight and thickness. Urethane based adhesives can provide more damping ability than conventional epoxy based adhesives. However, urethane is not available as a film, but as a liquid. When a liquid adhesive is applied to a surface and spread over a surface, unevenness and inconsistencies in the thickness of the adhesive can result.

### SUMMARY OF THE INVENTION

A method of forming a fan blade according an exemplary aspect of the present disclosure includes, among other things, the steps of applying an adhesive to an inner surface of a cover and moving a toothed instrument along the inner surface of the cover to spread the adhesive over the inner surface of the cover to form a plurality of rows of adhesive on the inner surface of the cover. The method further includes the steps of applying the inner surface of the cover to a fan blade body and curing the adhesive to secure the cover to the fan blade body.

In a further non-limiting embodiment of any of the forgoing method embodiments, the method may include a cover made of aluminum or an aluminum alloy.

In a further non-limiting embodiment of any of the forgoing method embodiments, the method may include a fan blade body made of aluminum or an aluminum alloy.

In a further non-limiting embodiment of any of the forgoing method embodiments, the method may include adhesive that is urethane.

In a further non-limiting embodiment of any of the forgoing method embodiments, the method may include a fan blade body having an inner surface including a plurality of cavities, and a low density filler is received in each of the plurality of cavities.

In a further non-limiting embodiment of any of the forgoing method embodiments, the method may include a low density filler that is aluminum foam.

In a further non-limiting embodiment of any of the forgoing method embodiments, the method may include the step of applying an adhesive to an inner surface of a cover near a first edge of the cover.

In a further non-limiting embodiment of any of the forgoing method embodiments, the method may include the step of moving a toothed instrument along an inner surface of a cover from a first edge of the inner surface of the cover to an opposing second edge of the inner surface of the cover.

In a further non-limiting embodiment of any of the forgoing method embodiments, the method may include the step of applying an inner surface of a cover to a fan blade body to spread rows of adhesive to form a layer of adhesive having a thickness.

In a further non-limiting embodiment of any of the forgoing method embodiments, the method may include a layer of adhesive having a thickness of about 0.005 inch (0.0127 cm) to about 0.015 inch (0.0381 cm).

In a further non-limiting embodiment of any of the forgoing method embodiments, the method may include the step of dampening vibrations with a layer of adhesive.

In a further non-limiting embodiment of any of the forgoing method embodiments, the method may include the step of curing an adhesive by employing a vacuum.

In a further non-limiting embodiment of any of the forgoing method embodiments, the method may include the step of curing an adhesive by employing pressure.

Another method of forming a fan blade according an exemplary aspect of the present disclosure includes, among other things, the step of applying a urethane adhesive near a first edge of an inner surface of a cover made of aluminum or an aluminum alloy. The method further includes the step of moving a toothed instrument along the inner surface of the cover from a first edge of the inner surface of the cover to an opposing second edge of the inner surface of the cover to spread the adhesive over the inner surface of the cover to create a plurality of rows of adhesive on the inner surface of the cover. The method further includes the steps of applying the inner surface of the cover to a fan blade body made of aluminum or aluminum alloy and curing the adhesive to secure the cover to the fan blade body.

In a further non-limiting embodiment of any of the forgoing method embodiments, the method may include a fan blade body having an inner surface including a plurality of cavities, and a low density filler is received in each of the plurality of cavities.

In a further non-limiting embodiment of any of the forgoing method embodiments, the method may include a low density filler that is aluminum foam.

In a further non-limiting embodiment of any of the forgoing method embodiments, the method may include the step of applying an inner surface of a cover to a fan blade body to spread the rows of adhesive to form a layer of adhesive having a thickness.

In a further non-limiting embodiment of any of the forgoing method embodiments, the method may include a layer of adhesive having a thickness of about 0.005 inch (0.0127 cm) to about 0.015 inch (0.0381 cm).

In a further non-limiting embodiment of any of the forgoing method embodiments, the method may include the step of dampening vibrations with a layer of adhesive.

In a further non-limiting embodiment of any of the forgoing method embodiments, the method may include the step of curing an adhesive by employing a vacuum and pressure.

These and other features of the present invention can be best understood from the following specification and drawings, the following of which is a brief description.

### BRIEF DESCRIPTION OF THE DRAWINGS

FIG. 1 illustrates a schematic view of a gas turbine engine;

FIG. 2 illustrates an exploded view of a fan blade;

FIG. 3 illustrates an inner surface of a cover of a fan blade with an adhesive applied near an edge;

FIG. 4 illustrates the inner surface of the cover of the fan blade once the adhesive has been spread over the inner surface of the cover with a toothed instrument;

FIG. 5 illustrates a toothed trowel used to spread the adhesive over the inner surface of the cover;

FIG. 6 illustrates a layer of adhesive after the application of the cover to a blade body; and

FIG. 7 illustrates a flowchart showing a method of attaching the cover to a blade body.

### DETAILED DESCRIPTION OF THE PREFERRED EMBODIMENTS

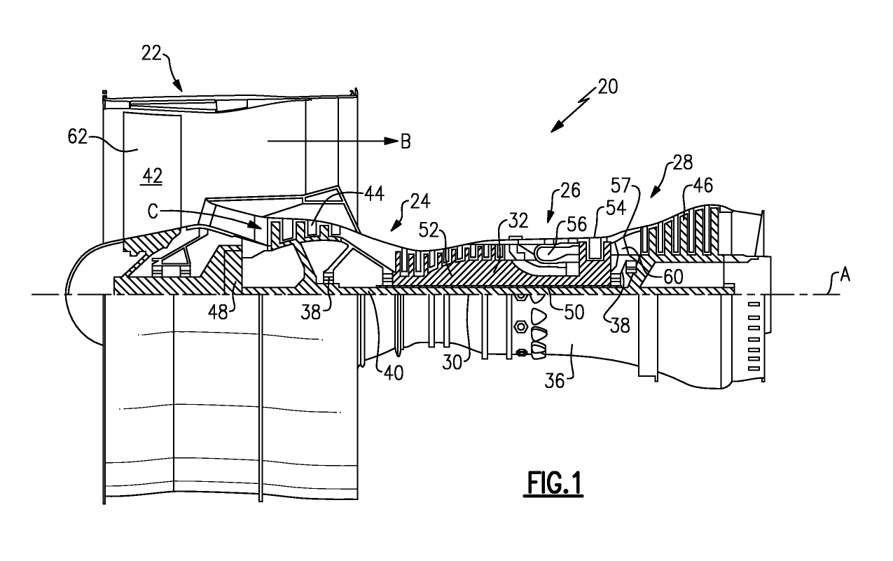

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features.

Although depicted as a turbofan gas turbine engine in the disclosed non-limiting embodiment, it should be understood that the concepts described herein are not limited to use with turbofans as the teachings may be applied to other types of turbine engines including three-spool or geared turbofan architectures.

The fan section 22 drives air along a bypass flowpath B while the compressor section 24 drives air along a core flowpath C for compression and communication into the combustor section 26 then expansion through the turbine section 28.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and a high pressure turbine 54.

A combustor 56 is arranged between the high pressure compressor 52 and the high pressure turbine 54.

A mid-turbine frame 58 of the engine static structure 36 is arranged generally between the high pressure turbine 54 and the low pressure turbine 46. The mid-turbine frame 58 further supports bearing systems 38 in the turbine section 28.

The inner shaft 40 and the outer shaft 50 are concentric and rotate via bearing systems 38 about the engine central longitudinal axis A, which is collinear with their longitudinal axes.

The core airflow C is compressed by the low pressure compressor 44, then the high pressure compressor 52, mixed and burned with fuel in the combustor 56, then expanded over the high pressure turbine 54 and low pressure turbine 46. The mid-turbine frame 58 includes airfoils 60 which are in the core airflow path C. The turbines 46, 54 rotationally drive the respective low speed spool 30 and high speed spool 32 in response to the expansion.

The engine 20 is in one example a high-bypass geared aircraft engine. In a further example, the engine 20 bypass ratio is greater than about six (6:1) with an example embodiment being greater than ten (10:1). The geared architecture 48 is an epicyclic gear train (such as a planetary gear system or other gear system) with a gear reduction ratio of greater than about 2.3 (2.3:1). The low pressure turbine 46 has a pressure ratio that is greater than about five (5:1). The low pressure turbine 46 pressure ratio is pressure measured prior to inlet of low pressure turbine 46 as related to the pressure at the outlet of the low pressure turbine 46 prior to an exhaust nozzle.

In one disclosed embodiment, the engine 20 bypass ratio is greater than about ten (10:1), and the fan diameter is significantly larger than that of the low pressure compressor 44. The low pressure turbine 46 has a pressure ratio that is greater than about five (5:1). The geared architecture 48 may be an epicycle gear train, such as a planetary gear system or other gear system, with a gear reduction ratio of greater than about 2.5 (2.5:1). It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 feet (10,668 meters), with the engine at its best fuel consumption, also known as “bucket cruise Thrust Specific Fuel Consumption (‘TSFC’),” is the industry standard parameter of lbm of fuel being burned divided by lbf of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.45.

“Low corrected fan tip speed” is the actual fan tip speed in feet per second divided by an industry standard temperature correction of [(Tambient deg R)/518.7)^{0.5}]. The “Low corrected fan tip speed” as disclosed herein according to one non-limiting embodiment is less than about 1150 feet per second (351 meters per second).

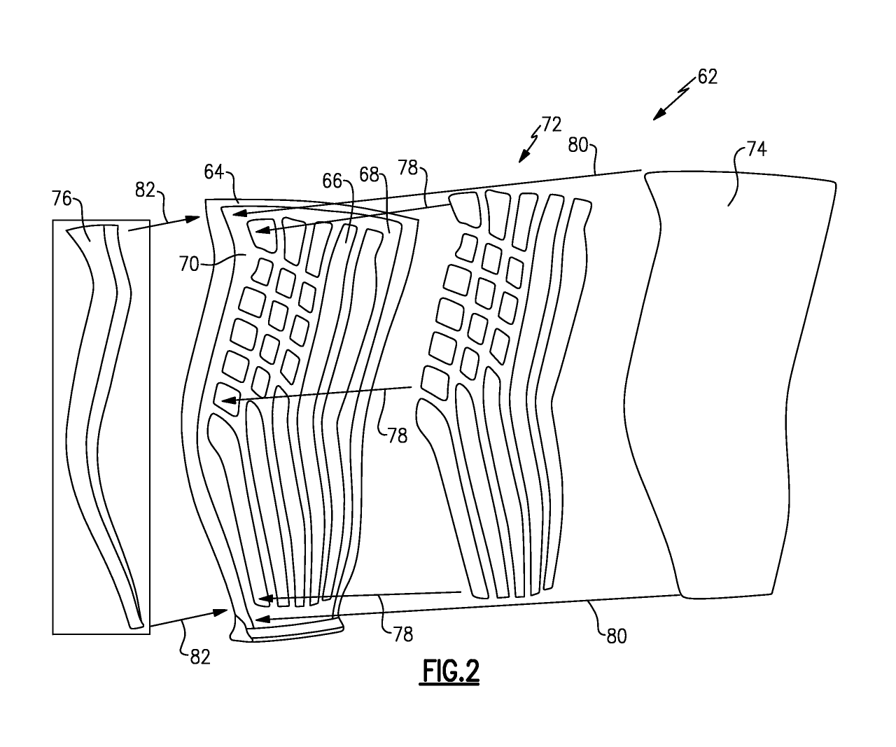

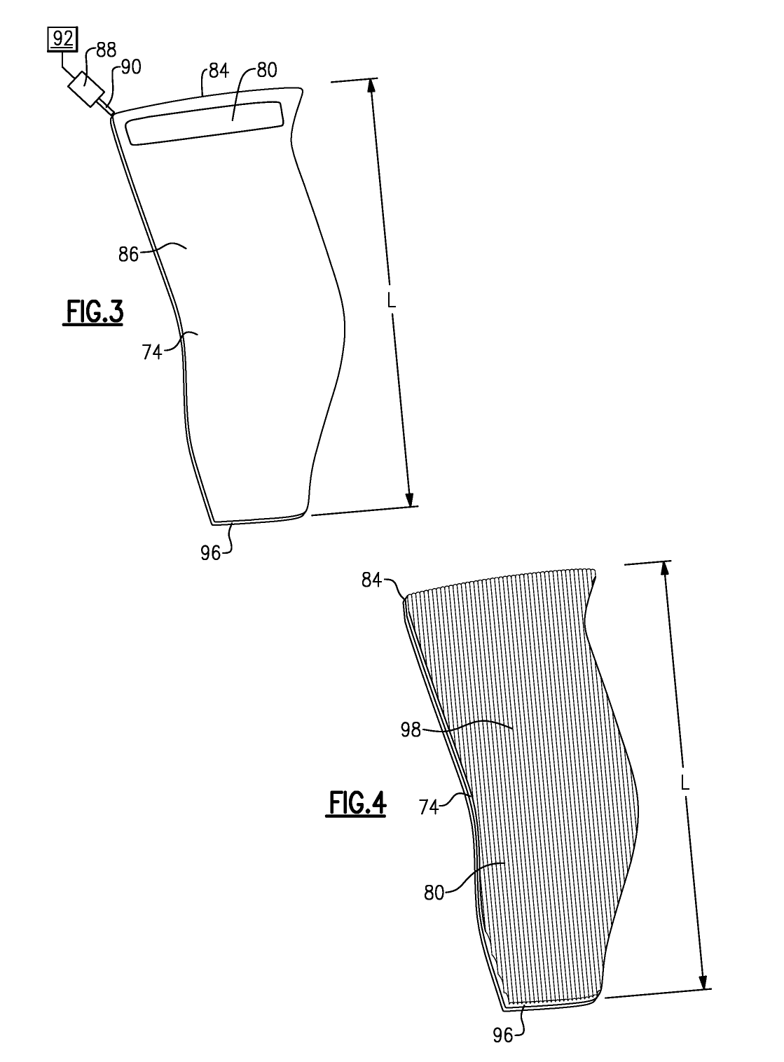

The fan 42 includes a plurality of hybrid metallic fan blades 62. As shown in FIG. 2, each fan blade 62 includes a blade body 64 having an inner surface 70 including a plurality of cavities 66, such as grooves or openings, surrounded by ribs 68. A plurality of strips or pieces of a low density filler 72 are each sized to fit in one of the plurality of cavities 66. The fan blade 62 also includes a cover 74 and a leading edge sheath 76 attached to the blade body 64.

In one example, the blade body 64 is made of aluminum or an aluminum alloy. Employing aluminum or an aluminum alloy for the blade body 64 and the cover 74 provides a cost and weight savings. There is one strip or piece of the low density filler 72 for each of the plurality of cavities 66 of the blade body 64. In one example, the low density filler 72 is a foam. In one example, the foam is aluminum foam. The low density filler 72 is secured in the cavities 66 with an adhesive 78, shown schematically as arrows. In one example, the adhesive 78 is urethane. In another example, the adhesive 78 is an epoxy film.

The cover 74 is then secured to the blade body 64 with an adhesive 80, shown schematically as arrows. In one example, the adhesive 80 is urethane. In one example, the cover 74 is made of aluminum or an aluminum alloy. The adhesive 80 then cured during a bonding cure cycle in a pressure vessel.

The leading edge sheath 76 is then attached to the blade body 64 with an adhesive layer 82. In one example, the adhesive layer 82 includes an adhesive film supported by a scrim cloth. In one example, the adhesive film is an epoxy film. In one example, the scrim cloth is nylon. In one example, the scrim cloth is mesh in structure. In one example, the leading edge sheath 76 is made of titanium or a titanium alloy. The adhesive film in the adhesive layer 82 is then cured during a sheath bonding cure cycle in an autoclave.

To attach the cover 74 to the blade body 64, the adhesive 80 is applied near a first edge 84 of an inner surface 86 of the cover 74. The adhesive 80 is contained in a body 88 and is dispensed through a nozzle 90. The adhesive 80 can be applied manually or robotically, shown schematically as a box 92.

As shown in FIG. 4, once the adhesive 80 is applied, a toothed instrument 94 is positioned on the inner surface 86 of the cover 74 and moved along the length L of the cover 74 from the first edge 84 to an opposing second edge 96. After the toothed instrument 94 is along the length L of the inner surface 86 of the cover 74, a plurality of rows 98 of adhesive 80 are defined.

As shown in FIG. 5, in one example, the toothed instrument 94 is a toothed trowel that includes a plurality of teeth 100 that are separated by a space 102. In one example, the height of the space 102 between each tooth 100 is ⅛ of an inch (0.3175 cm). In one example, the teeth 100 are spaced apart by a distance of ⅛″ (0.1375 cm). The depth, shape and spacing of the teeth 100 determine a final cured bondline thickness of the adhesive 80 by controlling an amount of the adhesive 80 on the inner surface 86 of the cover 74. In one example, the toothed instrument 94 is made of plastic. In one example, the tooth instrument 94 is a roller including a plurality of teeth. As the roller is moved over the inner surface 86 of the cover 74, the plurality of teeth create the plurality of rows 98 of adhesive 80.

The toothed instrument 94 controls the amount and distribution of the adhesive 80 spread over the inner surface 86 of the cover 74 to provide consistency and to remove any excess adhesive 80. This also allows for consistency for different fan blades 62, reducing weight variations in different fan blades 62. The toothed instrument 94 makes application of the adhesive 80 on the inner surface 86 of the cover 74 less sensitive to variation as it removes excess adhesive 80 and leaves a consistent amount of adhesive 80 on the cover 74. This also allows for the adhesive 80 to be applied manually without the use of a machine or robot.

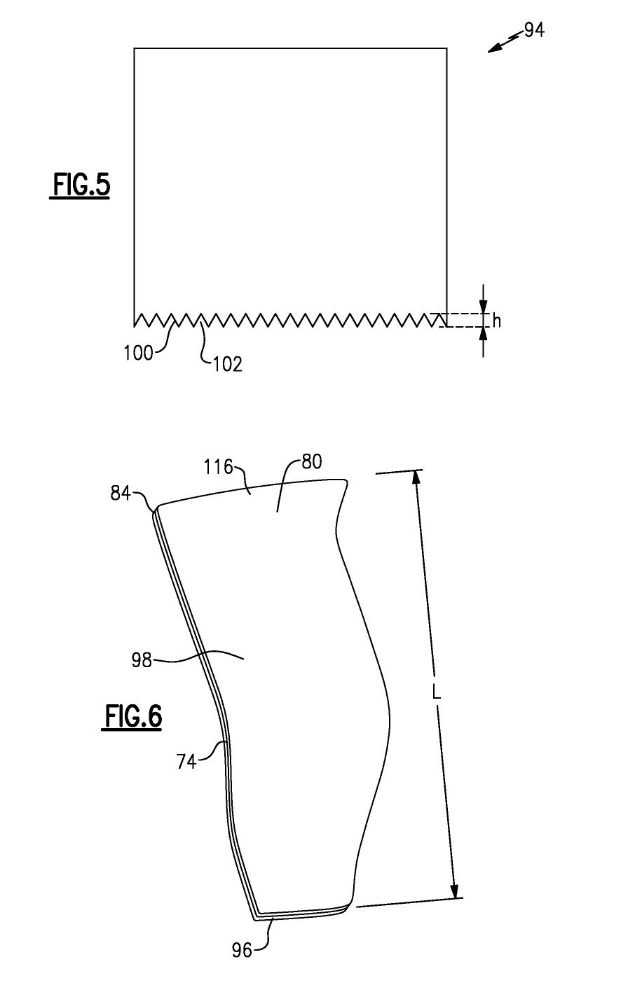

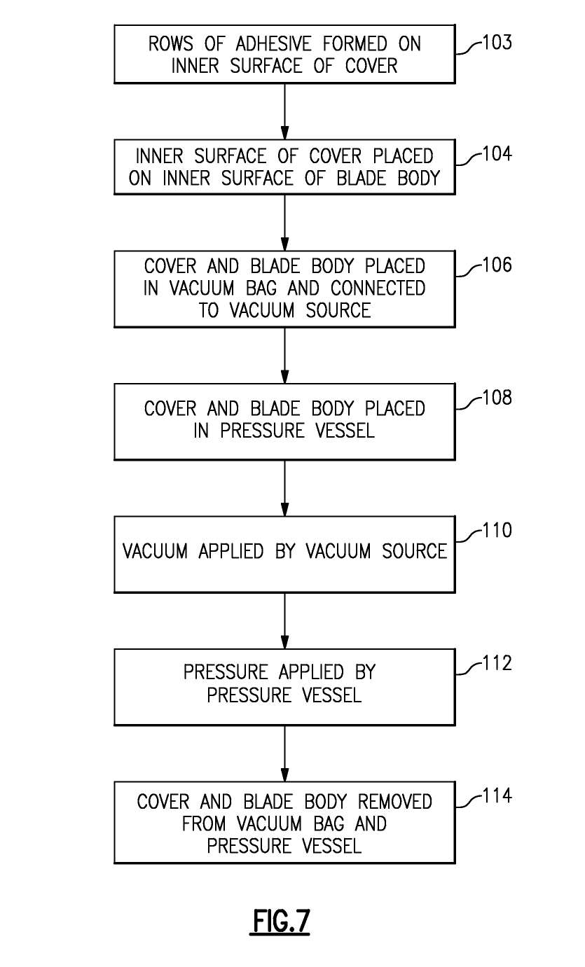

As shown in FIG. 7, after the rows 98 of adhesive 80 are formed on the inner surface 86 of the cover 74 in step 103, the cover 74 is then placed over the inner surface 70 of the blade body 64 in step 104 (after the attachment of the low density filler 72 in the cavities 66 of the blade body 64). As shown in FIG. 6, once the cover 74 is applied on the inner surface 70 of the blade body 64 (the blade body 64 is not shown in FIG. 6), the rows 98 of adhesive 80 spread to form a layer 116 of adhesive 80 of uniform thickness that covers the inner surface 86 of the cover 74.

In step 106, the cover 74 and the blade body 64 are sealed in a vacuum bag and connected to a vacuum source to evacuate the vacuum bag of air. The vacuum bag is removed from the vacuum source, and inn step 108, the cover 74 and the blade body 64 are then placed in a pressure vessel. The vacuum bag is then reattached to another vacuum source once the vacuum bag is located inside the pressure vessel. In step 110, a vacuum is applied to the vacuum bag by the another vacuum source to continue to evacuate the vacuum bag of air.

In step 112, pressure is then applied by the pressure vessel, curing the layer 116 of adhesive 80. In one example, the pressure vessel applies about 90 psi of pressure for at least 90 minutes. In one another example, the pressure vessel applies about 45 psi of pressure for at least 90 minutes. In step 114, the attached cover 74 and the blade body 64 are then removed from the vacuum bag and the pressure vessel. In one example, if the adhesive 80 is urethane, the layer 116 of adhesive 80 has a hardness over about 80 durometer Shore A after a secondary elevated cure at about 250° F.

Once cured, the layer 116 of adhesive 80 has a thickness of about 0.005 inch (0.0127 cm) to about 0.015 inch (0.0381 cm). The layer 116 of adhesive 80 not only secures the cover 74 to the blade body 64, but also provides a dampening function. As the fan blade 62 vibrates, the layer 116 of adhesive 80 absorbs vibrations to provide a dampening effect.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A method of forming a fan blade, the method comprising the steps of:
applying an adhesive to an inner surface of a cover;
moving a toothed instrument along the inner surface of the cover to spread the adhesive over the inner surface of the cover to form a plurality of rows of adhesive on the inner surface of the cover;
applying the inner surface of the cover to a fan blade body; and
curing the adhesive to secure the cover to the fan blade body.

2. The method as recited in claim 1 wherein the cover is made of aluminum or an aluminum alloy.

3. The method as recited in claim 1 wherein the fan blade body is made of aluminum or an aluminum alloy.

4. The method as recited in claim 1 wherein the adhesive is urethane.

5. The method as recited in claim 1 wherein an inner surface of the fan blade body includes a plurality of cavities, and a low density filler is received in each of the plurality of cavities.

6. The method as recited in claim 5 wherein the low density filler is aluminum foam.

7. The method as recited in claim 1 where the step of applying the adhesive to the inner surface of the cover includes applying the adhesive near a first edge of the cover.

8. The method as recited in claim 7 wherein the step of moving the toothed instrument along the inner surface of the cover includes moving the toothed instrument from the first edge of the inner surface of the cover to an opposing second edge of the inner surface of the cover.

9. The method as recited in claim 1 wherein the step of applying the inner surface of the cover to the fan blade body spreads the rows of adhesive to form a layer of adhesive having a thickness.

10. The method as recited in claim 9 wherein the thickness is about 0.005 inch (0.0127 cm) to about 0.015 inch (0.0381 cm).

11. The method as recited in claim 9 including the step of dampening vibrations with the layer of adhesive.

12. The method as recited in claim 1 wherein the step of curing the adhesive includes employing a vacuum.

13. The method as recited in claim 1 wherein the step of curing the adhesive includes employing pressure.

14. A method of forming a fan blade, the method comprising the steps of:
applying an adhesive near a first edge of an inner surface of a cover of the cover, wherein the cover is made of aluminum or an aluminum alloy, and the adhesive is urethane;
moving a toothed instrument along the inner surface of the cover from the first edge of the inner surface of the cover to an opposing second edge of the inner surface of the cover to spread the adhesive over the inner surface of the cover to create a plurality of rows of adhesive on the inner surface of the cover;
applying the inner surface of the cover to a fan blade body, wherein the fan blade body is made of aluminum or an aluminum alloy; and
curing the adhesive to secure the cover to the fan blade body.

15. The method as recited in claim 14 wherein an inner surface of the fan blade body includes a plurality of cavities, and a low density filler is received in each of the plurality of cavities.

16. The method as recited in claim 14 wherein the low density filler is aluminum foam.

17. The method as recited in claim 14 wherein the step of applying the inner surface of the cover to the fan blade body spreads the rows of adhesive to form a layer of adhesive having a thickness.

18. The method as recited in claim 17 wherein the thickness is about 0.005 inch (0.0127 cm) to about 0.015 inch (0.0381 cm).

19. The method as recited in claim 17 including the step of dampening vibrations with the layer of adhesive.

20. The method as recited in claim 14 wherein the step of curing the adhesive includes employing a vacuum and pressure.
